(19) United States
(12) Patent Application Publication
(10) Pub. No.: US 2018/0358864 A1
(43) Pub. Date: Dec. 13, 2018

(54) ELECTRICAL WORKING MACHINE

(71) Applicant: IPROTEC MASCHINEN- UND EDELSTAHLPRODUKTE GMBH, Petershagen-Friedewalde (DE)

(72) Inventor: Guido KOCHSIEK, Leopoldshoehe (DE)

(21) Appl. No.: 16/064,238

(22) PCT Filed: Dec. 21, 2016
(86) PCT No.: PCT/EP2016/082203

§ 371 Date: Jun. 20, 2018

(30) Foreign Application Priority Data
Dec. 21, 2015 (DE) 10 2015 122 380.5

(51) Int. Cl. H02K 7/00; F16D 1/08; F16D 1/10

(52) U.S. Cl. CPC H02K 7/003; F16D 2001/102; F16D 1/10; F16D 1/0858

(57) ABSTRACT

The aim of the disclosure is to simplify electrical working machines with respect to their structure and assembly and to improve their power. In order to achieve said aim, the disclosure proposes to equip an electrical working machine with elements for transmitting torques, in which at least one pair of elements is designed as a non-circular connection.

### CROSS-REFERENCE TO RELATED APPLICATIONS

This application is a National Stage of International Application No. PCT/EP2016/082203, filed on Dec. 21, 2016, and published in German as WO2017/108967 A1 on Jun. 29, 2017. This application claims the priority to German Patent Application No. 10 2015 122 380.5, filed on Dec. 21, 2015. The entire disclosures of the above applications are incorporated herein by reference.

### FIELD

Electric working machines are electric motors, power generators and the like.

### BACKGROUND

This section provides background information related to the present disclosure which is not necessarily prior art.

Within the electric motor or also in the case of power generators there are a number of connections which have to transmit torque. Depending on the type of motor, different motor concepts are used. In all motors, however, components are required on the motor shaft which are responsible for driving the motor or generating electricity in the case of the generator. These have to be permanently connected to the motor shaft/generator shaft so that they cannot rotate. In certain motors, further components are required, which also have to be connected to the motor shaft so that they cannot rotate. The components to be connected to the motor shaft are, for example, a collector, armature (winding), rotor plate package, commutator, etc.

Most connections in the generator and electric motor construction are designed as a spline, a feather key connection or a shrink connection.

Shrink connections in particular involve a large amount of installation work with corresponding costs (heating or cooling of the components, unfavourable handling of hot or cold components, high energy costs during assembly, possible distortion of the components during heating, high damage potential due to improper heating) and technical disadvantages during assembly (loss of running when joining long connections due to too rapid cooling during assembly). A correction/disassembly option is no longer possible once the shrink connection has cooled down. During servicing work, non-destructive disassembly is not possible.

Other connections (splines, feather key connections) have technical disadvantages and usually do not make optimum use of the installation space. For example, splines lose their running ability when they have to be hardened. Feather key connections are among the poorest types of connections in the manufacturing industry (unbalance, notch effect, expensive manufacture, expensive assembly, unfavourable torque behaviour, backlash).

### SUMMARY

This section provides a general summary of the disclosure, and is not a comprehensive disclosure of its full scope or all of its features.

The present disclosure is based on the task of simplifying the construction and assembly of electric working machines.

For the solution of this task, the disclosure proposes an electric working machine with the features of claim 1. The following description presents further independent inventive solutions.

The aim of the present disclosure is to optimise the production processes, reduce the production costs and optimise the connections in such a way that installation space and weight can be saved, assembly advantages achieved and ease of servicing increased.

The disclosure proposes that at least one of the connections used for torque transmission be designed in such a way that the elements to be connected—usually shaft/hub assemblies—have a non-circular cross-section. These are called out-of-round connections—in the specific case polygonal connections. For the purposes of the present disclosure, the term “out-of-round connections” is generally used for non-round elements, i.e. those which do not have a circular cross-section. Polygonal connections, on the other hand, are specific out-of-round connections which can produce contours called cycloids, for example. These include hypocycloids, epicycloids, shortened and extended versions and the like.

This is understood to mean elements produced by innovative manufacturing technologies, especially the out-of-round turning of manufactured elements. These do not have a circular cross-section, but a cross-section which deviates from this, which can also be polygonal. It is self-evident that on the one hand an octagonal hub, for example, which accommodates an octagonal end of a shaft makes assembly and maintenance considerably easier, while at the same time enabling significantly better torque transmission. During production, the novel out-of-round turning processes also reduce the amount of material required for production, as well as enabling a faster machining time. Furthermore, less production energy is required.

These connections are characterised by: freedom from unbalance. Zero backlash, self-centering, low notch effect, optimum torque behaviour in the smallest installation space, simple assembly, high running quality even in the case of hardened connections.

Through the use of polygonal steps or conical polygonal connections, almost all connections in the electric motor or generator can be designed as out-of-round connections.

Polygonal (non-round) step connections are particularly suitable for the replacement of shrink connections, as the heating or cooling of the components is not required. Installation can be greatly simplified. Alternatively, a conical out-of-round profile can be used. Through the use of out-of-round connections, the connection length can be reduced and installation space saved or installation space released for additional functions (e.g. fits, . . . ).

The advantages of such a connection are: greatly simplified assembly with significantly lower costs (no heating of the components required), shortening of the connection length due to a non-circular positive fit instead of a round frictional connection or due to a non-circular positive and frictional connection, a gain in installation space, weight reduction (energy efficiency, an improved level of efficiency, better performance), high running quality (no unbalance) after the greatly simplified assembly process. Components can be dismantled and then reinstalled (significantly lower repair costs for a motor).

The use of polygonal/out-of-round connections in the electric motor or generator results in considerable improvements and increases the operational reliability of the drive, as form-fit connections can be used in all connections. The use of out-of-round connections opens up further possibilities for the motor developer to accommodate more power and/or more functionality in the same installation space. The use of out-of-round connections can significantly reduce production costs, while the energy efficiency is increased.

As an additional inventive solution, it is proposed that the output shaft end should also be designed to be non-circular. If out-of-round connections are used anyway, this connection can be co-produced in one clamping operation, which has a positive effect on the production quality and production costs. The same applies to the machining of round sections of the motor shaft (e.g. bearing seats) and out-of-round connections in one clamping operation in order to improve the running quality between the individual sections. This enables higher rotational speeds to be achieved on the finished product. The technical advantages of an out-of-round connection also at the output shaft end are: no unbalance, self-centering, more compact design with the same performance capability, zero backlash, etc.

In addition, it is also proposed, as another independent inventive solution, that the fan wheel of a motor/generator should also be connected in a polygonal/out-of-round manner to the shaft. Here too, an out-of-round step design or conical out-of-round profile is suitable as a connection form.

According to the disclosure, extended trochoids are particularly interesting when it comes to the connection of sheet packages and rotor shaft. This is particularly the case because the counterpart is a sheet metal part.

The inventive solution is characterised by a high level of economic efficiency due to the use of out-of-round turning processes. This enables a high degree of precision, so that connections can be created that are no longer subject to backlash, as is the case, for example, with splines. There is also no unbalance, as is the case with feather key connections, for example. The out-of-round turning process enables the production of torsionally rigid, secure oversize connections. Joining can be carried out without heating or cooling, especially when using a step design, conical connections or comparable connections, is self-centering and, compared to conventional spline connections, can be accommodated in a smaller installation space due to better force transmission properties or allow higher operational reliability and/or the transmission of larger forces in the same installation space. The connecting elements (shaft and hub) can be manufactured using the same process.

Particularly in the case of the connection of the stack of sheets to the rotor shaft, extended forms can be used, for example an extended trochoid, because the counterpart, i.e. the stack of sheets, cannot be produced by machining.

According to the disclosure, the individual elements of a polygonal connection can be formed from different materials, which also leads to simplifications and possibilities for improvement.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 A schematic representation of a non-round shaft-hub connection in the output shaft area of an electric motor;

FIG. 1a A force distribution curve relating to the shaft-hub connection according to FIG. 1;

FIG. 2 A schematic illustration of a non-round shaft-hub connection between the sheet package and motor shaft (rotor);

FIG. 2a A force distribution curve relating to the shaft-hub connection according to FIG. 2 and

FIG. 3 A schematic illustration of the non-round shaft-hub connection according to the disclosure in line of sight III according to FIG. 2.

Corresponding reference numerals indicate corresponding parts throughout the several views of the drawings.

### DETAILED DESCRIPTION

Example embodiments will now be described more fully with reference to the accompanying drawings.

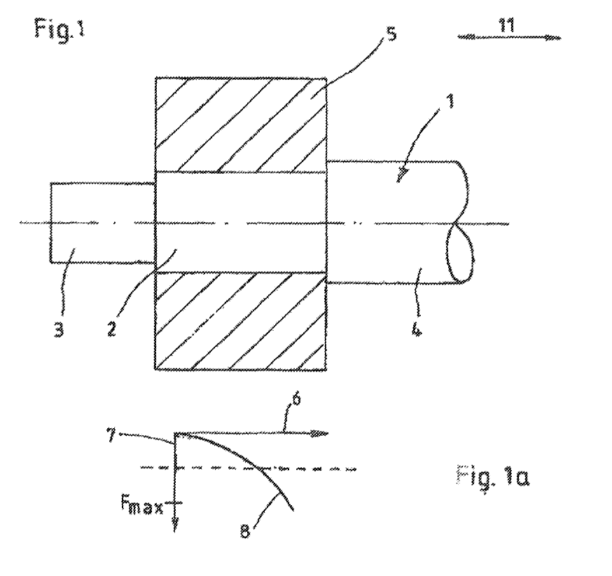

FIG. 1 shows a shaft-hub connection with a hub seat 2 provided by a shaft 1 and a hub of a component 5, for example a gear wheel, received by the hub seat 2. The hub seat 2 and the hub of component 5 form a polygonal connection, i.e. the hub seat 2 has a polygonal outer contour in cross-section, while component 5, for example, has a receptacle designed as a bore with an inner contour corresponding to the outer contour of the hub seat 2. The polygon profile used can be a pentagon, for example. As a matter of principle, the polygon profile, as an out-of-round profile, can of course have a corresponding number of corners as required. Accordingly, the disclosure is not limited to a pentagonal polygon profile.

As the illustration in FIG. 1 shows, the hub seat 2 and the component 5 received by it are of equal length in the longitudinal direction 11 of the shaft 1 and of equal width with respect to the sheet plane according to FIG. 1. With reference to the drawing plane according to FIG. 1, the left and right sides of the hub seat 2 are each limited by a connection area 3 or a connection area 4, with connection areas 3 and 4 being circular in cross-section, unlike the hub seat 2.

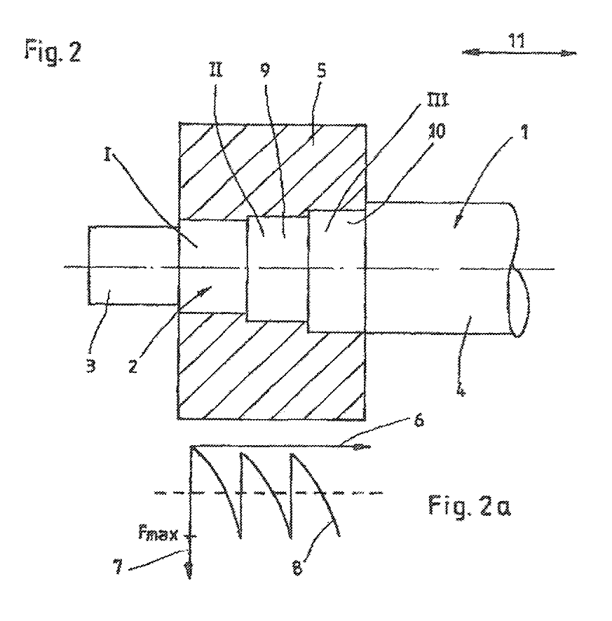

As the illustration in FIG. 2 shows, the hub seat 2 in the design example shown has two further radial shoulders 9 and 10, so that a three-stage hub seat 2 is formed with the three stages I, II and III. The hub of component 5—a stack of sheet metal—is designed accordingly for the inventive multistage aspects of the hub seat 2.

The individual stages I, II and III of the hub seat are of the same width with respect to the drawing plane according to FIG. 2, i.e. of the same length with respect to the longitudinal direction 11 of the motor shaft 1.

The radial shoulder 9, which forms the second stage II of the hub seat 2, projects over the first stage I of the hub seat 2 in the radial direction by at least a few—and up to several—millimetres, depending on the design and application. In the same way, the third stage III formed by radial shoulder 10 projects over the second stage II of the hub seat 2 provided by radial shoulder 9 in the radial direction.

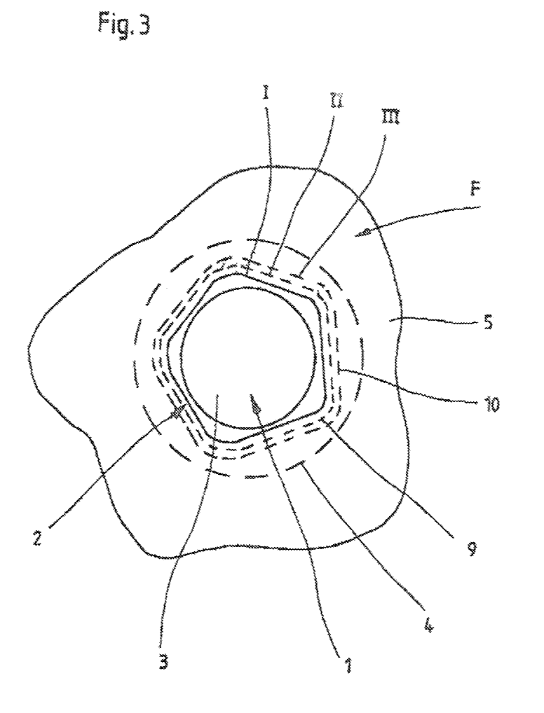

FIG. 3 shows the shaft-hub connection according to the disclosure in the direction of sight III according to FIG. 2. From this illustration, the individual radial shoulders 9 and 10 and the individual stages I, II and III of the hub seat are clearly visible. This illustration shows in particular that the hub seat 2 forms a pentagonal polygon profile, whereas the connection areas 3 and 4 adjoining the hub seat 2 on both the left and right sides with reference to the illustration according to FIG. 2 are circular in cross-section.

If, in a load situation, a force—for example with reference to the drawing plane according to FIG. 2 on the right-hand side of component 5—acts on the same as shown in FIG. 3 by force arrow F, this will result in a load on shaft 1 in the area of the hub seat 2, as shown as an example in FIG. 2a. FIG. 2a shows a diagram depicting the force and/or stress distribution 8 in the area of the hub seat 2 of the shaft 1, where the force introduced into the shaft 1 is transferred away on the y axis 7 via the axial extension of the hub seat 2 according to the x axis 6. As can be seen from this diagram, this results in a force or stress curve 8, which increases from left to right with reference to the drawing plane according to FIG. 2 for each stage I, II and III of the hub seat 2. With reference to the drawing plane according to FIG. 2, the maximum load results on the right-hand side of each step I, II and III of the hub seat 2.

At this point it should be emphasised that FIGS. 1a and 2a are provided for illustrative purposes only and are in no way intended to be scientifically or technically correct.

The force peaks define an average force, which corresponds approximately to the mean value between 0 and Fₘₐₓ. This average force is the measure of the efficiency of the shaft-hub connection and this mean value is shown as a dashed line.

For a state-of-the-art shaft-hub connection, a force or stress distribution 8 results, as shown in FIG. 1a. A comparison of the diagrams according to FIG. 1a and FIG. 2a shows that either the total force introduced into the hub seat 2 is of equal size, but that force distribution with regard to the maximum force acting on the individual stages I, II and III of the hub seat 2 is achieved by the design according to the disclosure. Or conversely, the shaft-hub connection according to the disclosure is more resilient and can transmit a higher average force. As a result, in the form of the inventive design, the maximum load on the shaft 1 is minimised compared to the state of the art for the same application of force. The minimisation of the maximum load is achieved by a distribution of the maximum forces and/or stresses onto the individual stages I, II and III of the hub seat 2 according to the form of the inventive design. Due to this stress distribution, improved—i.e. reduced—contact corrosion can be achieved compared to the state of the art. Or alternatively, the inventive shaft-hub connection can be regarded as significantly more efficient, i.e. it represents a significant improvement in every respect. Further optimisations of the function of the connection can be achieved by means of targeted different oversizes in the various stages.

The application of this shaft-hub technology to the torque-transmitting connections in an electric working machine is the subject of the present patent application. The general diagrams based on the design examples show the resulting advantages for electric working machines.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. An electrical working machine with elements provided for transmitting torques, wherein at least one element has a connection area with an out-of-round cross-section.

2. The electrical working machine according to claim 1, wherein the output shaft end has an out-of-round cross-section.

3. A method of producing the electrical working machine according to claim 1, wherein the area with an out-of-round cross-section is produced using an out-of-round turning process.

4. The method according to claim 3, wherein the area with an out-of-round cross-section is produced using an out-of-round turning process in the same clamping operation used for turning round areas.

5. The electrical working machine according to claim 1, wherein the area with an out-of-round cross-section has a cycloid contour.

6. The electrical working machine according to claim 1, wherein the area with an out-of-round cross-section is polygonal and has stages of different diameters over its length.

7. The electrical working machine according to claim 1, wherein the area with an out-of-round cross-section is conical.

8. The electrical working machine according to claim 1, wherein it comprises a plurality of elements with areas with an out-of-round cross-section.
